(19) United States
(12) Patent Application Publication
(10) Pub. No.: US 2023/0274408 A1
(43) Pub. Date: Aug. 31, 2023

(54) INSPECTION DEVICE

(71) Applicant: FANUC CORPORATION, Yamanashi (JP)

(72) Inventor: Naoto KOBAYASHI, Yamanashi (JP)

(21) Appl. No.: 18/005,671

(22) PCT Filed: Jul. 26, 2021
(86) PCT No.: PCT/JP2021/027522

§ 371 Date: Jan. 17, 2023

(30) Foreign Application Priority Data
Jul. 27, 2020 (JP) 2020-126661

(51) Int. Cl. G06T 7/00; G06N 20/00

(52) U.S. Cl. CPC G06T 7/0004; G06N 20/00; G06T 2207/20081

(57) ABSTRACT

An inspection device stores an estimation result of a state of an inspection object and reliability of the estimation result in association with data related to the inspection object, and determines that a timing for executing additional learning or relearning has arrived when the stored data satisfies a predetermined condition. In executing the additional learning or relearning, the additional learning data is extracted from the stored data, learning data used in the additional learning or relearning is generated based on at least the extracted additional learning data, and a machine learning device is commanded to perform the additional learning or relearning using the created learning data.

### TECHNICAL FIELD

The present invention relates to an inspection device, and particularly relates to an inspection device that inspects an inspection object by an estimation result on a state of the inspection object based on data related to the inspection object using a trained learning model stored by a machine learning device.

### BACKGROUND ART

In a manufacturing site such as a factory, external appearance inspection is performed on products manufactured on a manufacturing line (for example, Patent Document 1). In order to perform the external appearance inspection of products, it is necessary to generate, by machine learning, a discriminator for sorting images into an image of a normal product or an image of an abnormal product based on image data obtained by capturing the images of the products using an imaging device.

As a method for inspecting an external appearance of a product, there is a method in which machine learning is performed based on image data obtained from an imaging device, and quality determination is then performed using a discriminator generated by machine learning. For example, the discriminator may be generated by performing learning using teacher data obtained by assigning a label indicating that a product is a non-defective product to image data obtained by capturing an image of the non-defective product and teacher data obtained by assigning a label indicating that a product is a defective product to image data obtained by capturing an image of the defective product among products manufactured by an industrial machine. The discriminator generated in this way is constructed to determine quality of data used in learning, and thus may perform erroneous determination for data other than learned data. As a countermeasure, there is additional learning/relearning that improves discrimination accuracy by adding new data to conventional learning data to perform training.

In performing the additional learning/relearning, the following steps are done.
1. Manually annotate (label) new data other than data used in learning.
2. Allow a user to check data and command execution of learning at an appropriate time.
3. Add the above-mentioned new data to learning data and perform machine learning.

### CITATION LIST

### Patent Literature

Patent Document 1: JP 2014-190821 A

### SUMMARY OF THE INVENTION

### Problem to be Solved by the Invention

As described above, in order to perform additional learning/relearning, manual annotation is necessary. However, there is a problem that it generally takes a lot of labor and time to manually annotate a large amount of image data.

In addition, skill of the user is required to ascertain a timing at which the additional learning/relearning needs to be performed in response to a certain amount of collection. Furthermore, it is necessary to use appropriate data in order to improve discrimination accuracy of the discriminator through the additional learning/relearning. However, without knowledge of machine learning, it is difficult to determine what type of data can be used for effective additional learning/relearning.

In this way, there is a problem in that manual work is essential for the additional learning/relearning, while a burden on the user who performs the work is heavy.

Therefore, there is a desire for technology for determining a timing of performing effective additional learning/relearning.

### Means for Solving Problem

When inspection is performed using a discriminator device (model) generated by machine learning, an inspection device according to an aspect of the invention stores data to be inspected together with a pseudo label and reliability for the data. Then, the above-mentioned problem is solved by using collection of a certain amount of data related to a predetermined level of reliability as a trigger of additional learning or relearning. Data related to a predetermined level of reliability and a pseudo label thereof are used for the additional learning or the relearning.

Further, an aspect of the invention is an inspection device for inspecting an inspection object by an estimation result of a state of the inspection object based on data related to the inspection object using a basic model, the basic model being a trained learning model stored in a machine learning device, the inspection device including an estimated data storage configured to store an estimation result of a state of an inspection object and reliability of the estimation result in association with the data related to the inspection object, a learning moment determinator configured to determine that a timing for executing additional learning or relearning has arrived when data stored in the estimated data storage satisfies a predetermined condition, a learning data generator configured to extract additional learning data from the data stored in the estimated data storage when the learning moment determinator determines that the timing for executing the additional learning or relearning has arrived, and to generate learning data used in the additional learning or relearning based on at least the extracted additional learning data, and a learning commander configured to command the machine learning device to perform the additional learning or relearning using the learning data generated by the learning data generator.

### Advantageous Effect of the Invention

According to one aspect of the invention, a user can determine a timing of effective additional learning or relearning without performing annotation or data examination work, so that learning can be performed efficiently, and a reduction of a burden on the user is expected.

### BRIEF DESCRIPTION OF DRAWINGS

FIG. 1 is a schematic hardware configuration diagram of an inspection device according to an embodiment;

FIG. 2 is a schematic functional block diagram of the inspection device according to an embodiment;

FIG. 3 is a diagram for illustrating an example of reliability;

FIG. 4 is a diagram for illustrating another example of reliability; and

FIG. 5 is a diagram showing an example of data stored in an estimated data storage.

### DESCRIPTION OF EMBODIMENTS

Hereinafter, embodiments of the invention will be described with reference to the drawings.

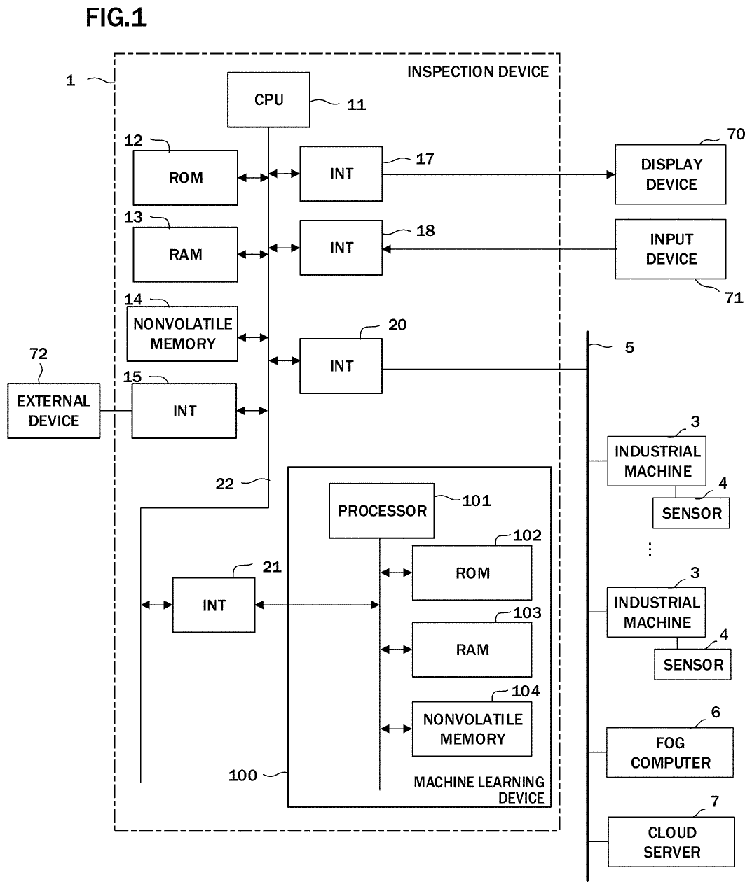

FIG. 1 is a schematic hardware configuration diagram showing a main part of an inspection device according to an embodiment of the invention.

For example, an inspection device 1 of the invention may be mounted as a controller device for controlling an industrial machine including inspection equipment based on a control program. Furthermore, the inspection device 1 may be mounted on a personal computer installed side by side with the controller device for controlling the industrial machine including the inspection equipment based on the control program, a personal computer connected to the controller via a wired/wireless network, a cell computer, a fog computer 6, and a cloud server 7. In the present embodiment, the inspection device 1 is mounted on the personal computer connected to the controller device via the network.

In the present embodiment, a CPU 11 provided in the inspection device 1 is a processor for controlling the inspection device 1 as a whole. The CPU 11 reads a system program stored in a ROM 12 via a bus 22 and controls the entire inspection device 1 according to the system program. A RAM 13 temporarily stores temporary calculation data, display data, various data input from the outside, etc.

For example, a nonvolatile memory 14 includes a memory backed up by a battery (not shown), an SSD (Solid State Drive) and so on, and retains a storage state even when power of the inspection device 1 is turned off. The nonvolatile memory 14 stores data read from an external device 72 via an interface 15, data input via an input device 71, data detected by a sensor 4 and acquired from an industrial machine 3 via a network 5, etc. The data stored in the nonvolatile memory 14 may be loaded in the RAM 13 during execution/use. In addition, in the ROM 12 various system programs such as a known analysis program are previously written.

The sensor 4 for detecting the external appearance and so on of an inspection object (a product to be inspected) is attached to the industrial machine 3. The industrial machine 3 includes, as an example, a robot having the sensor 4 serving as an imaging device attached to a tip thereof.

The interface 15 is an interface for connecting the CPU 11 in the inspection device 1 with the external device 72 such as a USB device. For example, data related to an operation of each industrial machine can be read from the external device 72. In addition, a program, setting data and so on edited in the inspection device 1 can be stored in an external storage means via the external device 72.

An interface 20 is an interface for connecting the CPU in the inspection device 1 with the wired or wireless network 5. The industrial machine 3, the fog computer 6, the cloud server 7, etc. are connected to the network 5 to exchange data with the inspection device 1.

Each piece of data read on the memory, data obtained as a result of executing a program or the like, data output from a machine learning device 100 described later, and so forth are output to and displayed on a display device 70 via an interface 17. In addition, the input device 71 including a keyboard, a pointing device, etc., transfers a command, data and so on based on an operation by an operator via an interface 18 to the CPU 11.

An interface 21 is an interface for connecting the CPU 11 and the machine learning device 100. The machine learning device 100 includes a processor 101 for controlling the entire machine learning device 100, a ROM 102 for storing a system program, etc., a RAM 103 for temporary storage in each process related to machine learning, and a nonvolatile memory 104 used to store a learning model, etc. The machine learning device 100 can observe each piece of information (for example, data indicating an operating state of the industrial machine 3) that can be acquired by the inspection device 1 via the interface 21. In addition, the inspection device 1 acquires a processing result which is output from the machine learning device 100 via the interface 21, stores and displays the acquired result, and further transmits the acquired result to another device via the network 5 or the like.

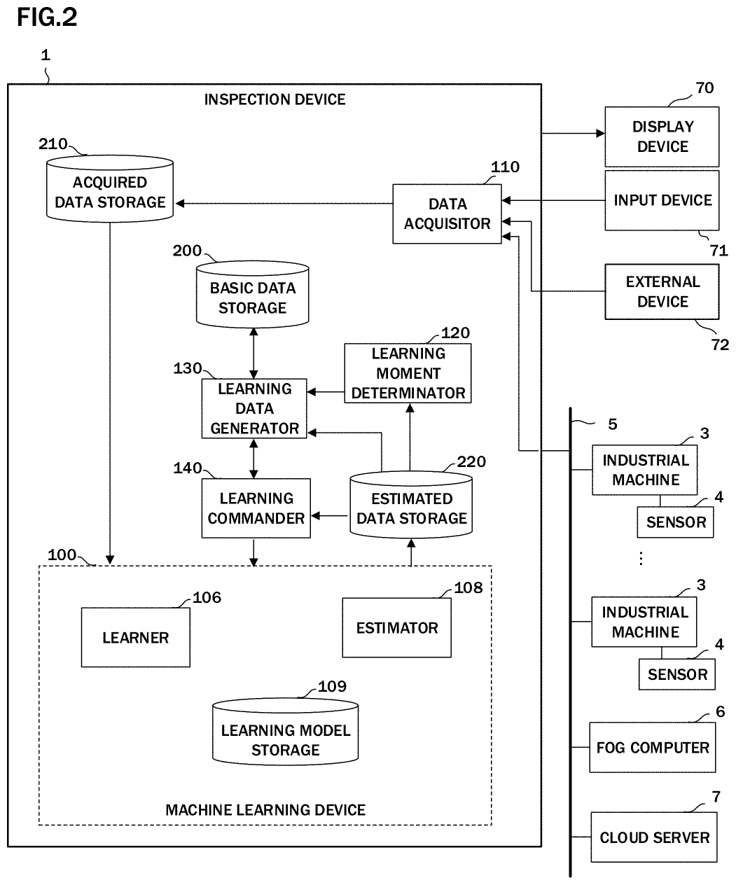

FIG. 2 illustrates a function provided in the inspection device 1 according to an embodiment of the invention as a schematic block diagram. Each function provided in the inspection device 1 according to the present embodiment is actualized by the CPU 11, provided in the inspection device 1 shown in FIG. 1, and the processor 101, provided in the machine learning device 100, executing a system program to control an operation of each unit in the inspection device 1 and the machine learning device 100.

The inspection device 1 according to the present embodiment includes a data acquisitor 110, a learning moment determinator 120, a learning data generator 130, and a learning commander 140. In addition, the machine learning device 100 provided in the inspection device 1 includes a learner 106 and an estimator 108. Furthermore, in the RAM 13 or the nonvolatile memory 14 in the inspection device 1, a basic data storage 200 for storing learning data (hereinafter referred to as basic learning data) used to generate a learning model stored in the machine learning device 100, an acquired data storage 210 serving as an area for storing data acquired by the data acquisitor 110 from the industrial machine 3 and so on, and an estimated data storage 220 for storing an estimation result by the estimator 108 in the machine learning device 100 are prepared in advance. In addition, on the RAM 103 or the nonvolatile memory 104 in the machine learning device 100, a learning model storage 109 serving as an area in which a learning model is stored is prepared in advance. In the inspection device 1 according to the present embodiment, a trained learning model (hereinafter referred to as a basic model) generated by machine learning with learning data previously stored in the basic data storage 200 is stored in the learning model storage 109.

The data acquisitor 110 is actualized by the CPU 11 provided in the inspection device 1 illustrated in FIG. 1 executing a system program read from the ROM 12. In the system program, arithmetic processings using the RAM 13 and the nonvolatile memory 14 by the CPU 11 and input control processings by the interface 15, 18, or 20 are mainly performed. The data acquisitor 110 acquires data related to an inspection object detected by the sensor 4 during normal operation of the industrial machine 3. The data acquisitor 110 acquires image data indicating an external appearance of an inspection object, for example, detected by the sensor 4 attached to the industrial machine 3, sound data generated by vibrating an inspection object at a predetermined frequency, and so on. The data acquired by the data acquisitor 110 may be image data in a raster format or in a predetermined image format obtained by processing the data in the raster format, or may be time-series data such as video data. In addition, the data acquisitor 110 may acquire data directly from the industrial machine 3 via the network 5, or may acquire data acquired and stored by the external device 72, the fog computer 6, the cloud server 7, and the like. The data acquired by the data acquisitor 110 is stored in the acquired data storage 210.

The estimator 108 provided in the machine learning device 100 is actualized by the processor 101 provided in the machine learning device 100 shown in FIG. 1 executing a system program read from the ROM 102. In the system program, arithmetic processings using the RAM 103 and the nonvolatile memory 104 by the processor 101 are mainly performed.

The estimator 108 estimates a state of an inspection object using a basic model stored in the learning model storage 109 based on data acquired by the data acquisitor 110 and stored in the acquired data storage 210. The estimation result by the estimator 108 includes at least a label (hereinafter referred to as a pseudo label) estimated for the inspection object and reliability associated with the pseudo label.

Here, the pseudo label may represent an estimation result identified using a basic model. For example, inspection for estimating whether a certain product is a non-defective product or a defective product based on image data of the product is taken into consideration. It is assumed that the basic model generated by performing learning in advance for the inspection is stored in the learning model storage 109. At this time, estimation based on predetermined data may be performed using the basic model, and when the basic model is identified as “non-defective product” for the data, a pseudo label for the data may be defined as a one-hot vector such as (non-defective product, defective product)=(1, 0). Conversely, when the basic model is identified as “defective product”, a pseudo label for the data may be defined as (non-defective product, defective product)=(0, 1).

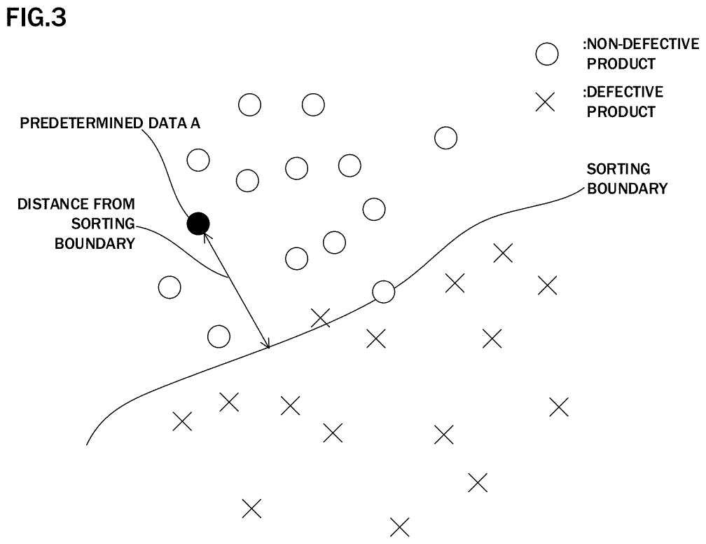

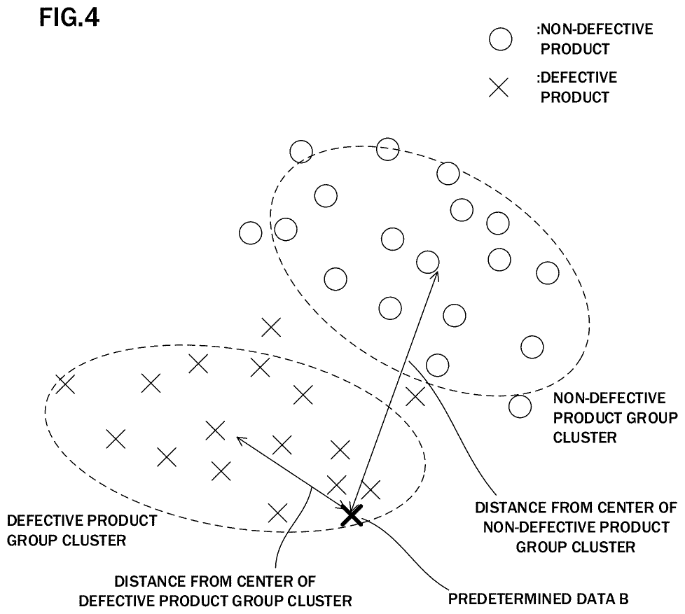

Meanwhile, the reliability may be data representing reliability of the pseudo label. The reliability may be a numerical value indicating a degree of credibility on a result of estimation by a basic model. For example, in the above example, when an identification result by the basic model for predetermined data is “non-defective product”, and an estimated score at that time is non-defective product=0.9 and defective product=0.1, the reliability that a pseudo label is (non-defective product, defective product)=(1, 0) may be 90%. Referring to this reliability, for example, as illustrated in FIG. 3, in the case where there is a basic model in which a sorting boundary is defined by a predetermined non-defective product group and a predetermined defective product group, when the basic model identifies predetermined data A as a non-defective product, reliability thereof may be defined as a score calculated based on a distance between predetermined data A and the basic model. In addition, for example, as illustrated in FIG. 4, in the case where there is a basic model that performs identification based on a cluster of a predetermined non-defective product group and a cluster of a predetermined defective product group, when the basic model identifies predetermined data B as a defective product, reliability thereof may be defined as a score calculated based on a distance (closeness) between predetermined data B and a center of the cluster of the defective product group and a distance (degree of separation) from a center of another cluster. Additionally, the reliability may be calculated from a degree of similarity with learning data, and when the basic model is a neural network, a degree of similarity with an output in an intermediate layer may be adopted. As the reliability, a predetermined numerical value that can define credibility of an identification result may be used according to a type of machine learning model.

Note that a data format of a pseudo label and reliability is not limited to the above description. For example, a pseudo label and reliability may be expressed as one piece of vector data. In this case, in the above example, the pseudo label and the reliability can be expressed as (non-defective product, defective product)=(0.9, 0.1).

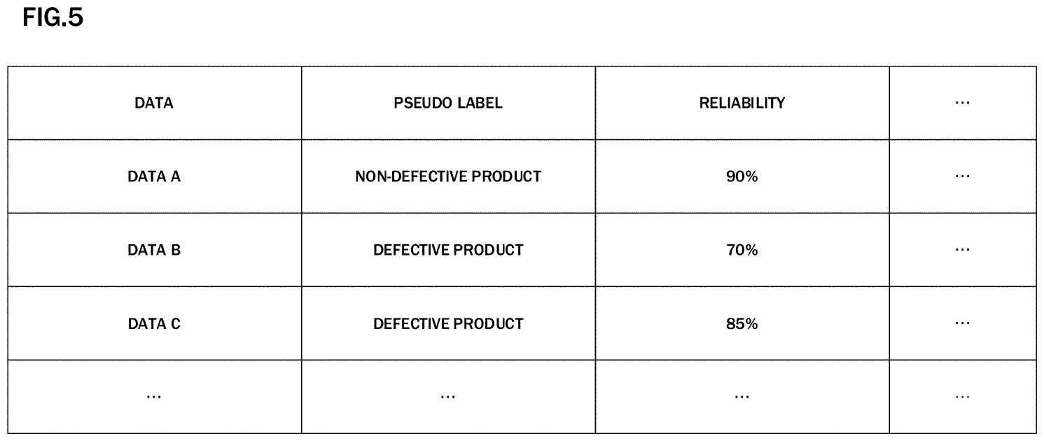

An estimation result by the estimator 108 is output via the interface 21 to the CPU 11, and then displayed on the display device 70 or transmitted via the network 5 to the industrial machine 3 or a computer such as the fog computer 6 or the cloud server 7. In addition, as illustrated in FIG. 5, an inspection result of an inspection object by the estimator 108 is stored in the estimated data storage 220 in association with data used for estimation.

The learning moment determinator 120 is actualized by the CPU 11 provided in the inspection device 1 illustrated in FIG. 1 executing a system program read from the ROM 12. In the system program, arithmetic processing using the RAM 13 and the nonvolatile memory 14 by the CPU 11 are mainly performed.

The learning moment determinator 120 determines a timing for executing additional learning or relearning according to a predetermined condition. Here, for example, the predetermined condition may be a condition using reliability of the data stored in the estimated data storage 220, the number of pieces of the data, etc. As an example of the predetermined condition, additional learning may be performed when the number of pieces of data having reliability less than or equal to a predetermined threshold value Cₜₕ₁ % (for example, 80%) is a predetermined threshold value Nₜₕ₁ (for example, 30) or more. An increase in the amount of data not having high reliability in an estimation result by a basic model means that the basic model has insufficient identification ability for an inspection object in a current environment. The above example of the condition is a condition indicating that the basic model has insufficient identification ability for an inspection object in a current environment. In such a case, additional learning or relearning needs to be performed for the basic model to generate a model more adapted to the inspection object in the current environment. In this way, a determination condition used by the learning moment determinator 120 determines a moment to improve adaptability of the currently used basic model to the current environment.

The learning data generator 130 is actualized by the CPU 11 provided in the inspection device 1 illustrated in FIG. 1 executing a system program read from the ROM 12. In the system program arithmetic processing using the RAM 13 and the nonvolatile memory 14 by the CPU 11 are mainly performed.

When the learning moment determinator 120 determines that a timing for executing additional learning or relearning has arrived, the learning data generator 130 generates learning data used in the additional learning or relearning. The learning data generator 130 extracts, as the additional learning data, data necessary to enable the basic model to perform more appropriate identification for the current environment from the estimated data storage 220. With regard to a label of the additional learning data, the pseudo label may be used without change. Then, learning data used in the additional learning or relearning is generated from the extracted additional learning data and the basic learning data stored in the basic data storage 200. For example, the learning data generator 130 extracts additional learning data from data serving as a trigger for determination of the learning moment determinator 120 to execute additional learning or relearning. In the above example, pieces of data, the number of which is predetermined nₜₕ₁ (for example, 10), having high reliability may be extracted as the additional learning data from pieces of data, the number of which is a predetermined threshold value Nₜₕ₁ or more, having reliability less than or equal to a predetermined threshold value Cₜₕ₁ % among pieces of the data stored in the estimated data storage 220, and the learning data of the additional learning or relearning may be generated from this data and the basic learning data. Alternatively, a predetermined number of pieces may be randomly extracted from data serving as a trigger, and learning data of the additional learning or relearning may be generated from this extracted data and the basic learning data. In addition, in this instance, the pieces may be extracted from the data serving as the trigger so that pseudo labels are not biased (so that the number of pseudo labels of non-defective products and the number of pseudo labels of defective products are the same).

The learning commander 140 is actualized by the CPU 11 provided in the inspection device 1 shown in FIG. 1 executing a system program read from the ROM 12. In the program, arithmetic processing using the RAM 13 and the nonvolatile memory 14 by the CPU 11 and input/output processing using the interface 21 are mainly performed.

The learning commander 140 commands the learner 106 provided in the machine learning device 100 to perform additional learning or relearning using the learning data used for the additional learning or relearning generated by the learning data generator 130. In the case of commanding that additional learning be performed, the learning commander 140 commands the learner 106 to perform the additional learning using the learning data generated by the learning data generator 130 for a basic model. In addition, in the case of commanding that relearning be performed, the learning commander 140 commands the learner 106 to perform the relearning using the learning data generated by the learning data generator 130 for an initialized model. With regard to a method of additional learning or relearning, a public value method of additional learning or relearning may be used as appropriate.

The learning commander 140 may perform predetermined verification on a new model obtained as a result of the additional learning or relearning by the learner 106, and determine whether to end the additional learning or relearning. For example, as a verification operation, the learning commander 140 may perform estimation using a new model for data having reliability equal to or greater than a predetermined threshold value Cₜₕ₃ % in the data stored in the estimated data storage 220. Then, the learning commander 140 may set a state in which an estimation result by the new model matches an estimation result by the basic model, and the reliability of the estimation result by the new model is all improved over reliability of the estimation result estimated using the basic model as an ending condition of the additional learning or relearning, which means that the new model is more adapted to the current environment than the basic model. In this instance, when it is determined that the new model is less adapted to the current environment than the basic model, or when it is determined that adaptation of the new model to the current environment is insufficient, the learning data generator 130 may be commanded to regenerate learning data used for the additional learning or relearning, and the learner 106 may be commanded to perform further the additional learning or relearning. When further the additional learning or relearning is performed, the learning commander 140 may command the learning data generator 130 to replace some additional learning data with other data stored in the estimated data storage 220. Then, for example, when the new model is not adapted to the current environment even after the additional learning or relearning is repeated a predetermined number of times, the learning commander 140 may interrupt repeated implementation of the additional learning or relearning, and display information thereof on the display device 70.

When the additional learning or relearning ends, the learning commander 140 may verify whether the new model can perform the similar level of inspection without any inconvenience when compared to the basic model. In this instance, for example, the learning commander 140 commands the estimator 108 to extract pieces of data, the number of which is greater than or equal to a predetermined threshold value Nₜₕ₃ (for example, 100), as sample data from the basic learning data, and perform an estimation process on the sample data respectively using both the new model and the basic model. Then, when the estimation result by the new model and the estimation result by the basic model satisfy a predetermined condition, it is determined that the new model is capable of performing more correct inspection when compared to the basic model. Here, for example, the predetermined condition may be a condition that the estimation result by the new model matches the estimation result by the basic model for all sample data. In addition to the above condition, the predetermined condition may also include a condition that the reliability of the estimation result by the new model exceeds the reliability of the estimation result by the basic model, or even when the reliability of the estimation result by the new model is less than the reliability of the estimation result by the basic model, a degree thereof is within a predetermined threshold value Cₜₕ₄ for all sample data. In addition, as another example of the predetermined condition, a situation of a manufacturing site in which a ratio of identifying non-defective products as defective products is less than or equal to a predetermined threshold value Eₜₕ₁ may be considered. As a result of verification, in the case where the new model is incapable of performing the similar level of inspection when compared to the basic model, the additional learning or relearning may be repeatedly implemented in the similar manner as described above.

Then, as a result of verification, when it is determined that the new model is more adapted to the current environment than the basic mode, or it is determined that the new model can perform the similar level of inspection as that of the basic model, the learning commander 140 adopts the new model as a model used for future inspection, and thereafter commands the learner 106 and the estimator 108 to treat the new model as the basic model.

The learner 106 provided in the machine learning device 100 is actualized by the processor 101 provided in the machine learning device 100 shown in FIG. 1 executing a system program read from the ROM 102. In the program, arithmetic processing using the RAM 103 and the nonvolatile memory 104 by the processor 101 is mainly performed.

The learner 106 generates a learning model by performing the additional learning or relearning using the learning data generated by the learning data generator 130 based on a command received from the learning commander 140 to store the generated learning model in the learning model storage 109. The machine learning performed by the learner 106 may be known unsupervised learning or supervised learning.

The inspection device 1 having the above configuration can determine a timing of effective additional learning or relearning without the user performing annotation or data examination work. Therefore, the learning can be performed efficiently, and a reduction of a burden on the user can be expected.

Even though one embodiment of the invention has been described above, the invention is not limited to the above-described examples of the embodiment, and can be implemented in various modes by adding appropriate modifications.

### EXPLANATIONS OF LETTERS OR NUMERALS

1 INSPECTION DEVICE
3 INDUSTRIAL MACHINE
4 SENSOR
5 NETWORK
6 FOG COMPUTER
7 CLOUD SERVER
11 CPU
12 ROM
13 RAM
14 NONVOLATILE MEMORY
15, 17, 18, 20, 21 INTERFACE
22 BUS
70 DISPLAY DEVICE
71 INPUT DEVICE
72 EXTERNAL DEVICE
110 DATA ACQUISITOR
120 LEARNING MOMENT DETERMINATOR
130 LEARNING DATA GENERATOR
140 LEARNING COMMANDER
200 BASIC DATA STORAGE
210 ACQUIRED DATA STORAGE
220 ESTIMATED DATA STORAGE
100 MACHINE LEARNING DEVICE
101 PROCESSOR
102 ROM
103 RAM
104 NONVOLATILE MEMORY
106 LEARNER
108 ESTIMATOR
109 LEARNING MODEL STORAGE

1. An inspection device for inspecting an inspection object by an estimation result of a state of the inspection object based on data related to the inspection object using a basic model, the basic model being a trained learning model stored in a machine learning device, the inspection device comprising:
an estimated data storage configured to store an estimation result of a state of an inspection object and reliability of the estimation result in association with the data related to the inspection object;
a learning moment determinator configured to determine that a timing for executing additional learning or relearning has arrived when data stored in the estimated data storage satisfies a predetermined condition;
a learning data generator configured to extract additional learning data from the data stored in the estimated data storage when the learning moment determinator determines that the timing for executing the additional learning or relearning has arrived, and to generate learning data used in the additional learning or relearning based on at least the extracted additional learning data; and
a learning commander configured to command the machine learning device to perform the additional learning or relearning using the learning data generated by the learning data generator.

2. The inspection device according to claim 1, wherein the data related to the inspection object is image data related to the inspection object.

3. The inspection device according to claim 1, wherein, when the number of pieces of data having the reliability less than or equal to a predetermined first threshold value is greater than or equal to a predetermined second threshold value in the data stored in the estimated data storage, the learning moment determinator determines the timing for executing the additional learning or relearning has arrived.

4. The inspection device according to claim 3, wherein the learning data generator extracts, as the additional learning data, pieces of data having high reliability in descending order from the data having the reliability less than or equal to the predetermined first threshold value in the data stored in the estimated data storage, the number of the pieces of data being a predetermined third threshold value.

5. The inspection device according to claim 3, wherein the learning data generator randomly selects and extract pieces of data from the data having the reliability less than or equal to the predetermined first threshold value in the data stored in the estimated data storage as the additional learning data, the number of the pieces of data being a predetermined third threshold value.

6. The inspection device according to claim 1, wherein the learning commander verifies a new model generated by the additional learning or relearning using the data stored in the estimated data storage, commands the learning data generator to regenerate learning data used in the additional learning or relearning when it is determined that the new model is less adapted to an environment acquired by the data stored in the estimated data storage than the basic model as a result of verification, and commands the machine learning device to perform the additional learning or relearning using the regenerated learning data.

7. The inspection device according to claim 1, wherein the learning commander verifies a new model generated by the additional learning or relearning using learning data used when the basic model is generated, commands the learning data generator to regenerate learning data used in the additional learning or relearning when it is determined that the new model is not allowed to perform the similar level of inspection as a level of inspection of the basic model as a result of the verification, and commands the machine learning device to perform the additional learning or relearning using the regenerated learning data.
